(19) United States
(12) Patent Application Publication
(10) Pub. No.: US 2014/0195534 A1
(43) Pub. Date: Jul. 10, 2014

(54) CREATING DIMENSION/TOPIC TERM SUBGRAPHS

(71) Applicant: INTERNATIONAL BUSINESS MACHINES CORPORATION, (US)

(72) Inventors: Judah M. Diament, Yorktown Heights, NY (US); Aliza R. Heching, New York, NY (US); Peter K. Malkin, Yorktown Heights, NY (US)

(73) Assignee: INTERNATIONAL BUSINESS MACHINES CORPORATION, Armonk, NY (US)

(21) Appl. No.: 13/736,543

(22) Filed: Jan. 8, 2013

(51) Int. Cl. G06F 17/30

(52) U.S. Cl. CPC G06F 17/30705
USPC 707/737

(57) ABSTRACT

A term graph for a group (G), where G is defined by a given set of values d for a set of dimensions (D) relative to a topic (X) may be created by retrieving a graph (H) comprising terms related to an entity and associated with topic X; identifying a node (N) that represents topic X in graph H; identifying resources (R) associated with topic X in group G (used or accessed by, or otherwise associated with values d in group (G); compiling a list (L) of terms used in the identified resources (R); and creating, starting from node N, a connected subgraph S representing the term graph, wherein each node in subgraph S represents one of the terms from list L and has a path to node N.

### CROSS-REFERENCE TO RELATED APPLICATIONS

The present invention is related to commonly-owned, co-pending U.S. patent application Ser. No.______ (Attorney Docket YOR920120885US1) entitled, “GUI FOR VIEWING AND MANIPULATING CONNECTED TAG CLOUDS” and filed on even date herewith, the entire contents and disclosure of which is expressly incorporated by reference herein as if fully set forth herein.

### FIELD

The present application relates generally to computers and computer applications, graph-based data structures and algorithms, and more particularly to creating dimension term subgraph.

### BACKGROUND

The backgrounds, skill set, and knowledge base of different people within a single organization often vary widely. As such, two such people may have difficulty communicating with each other about a matter of shared interest. In a manufacturing business, for example, senior executives may think about product lines in terms of cost, revenue, and financial efficiency of the production process, while those managing the production lines may be focused on the machinery/robotics used in production, the skills balance and morale of the workers on the production line, safety regulations, etc. Were the senior executive and the production line manager to have a conversation about a certain product, they are likely to have a difficult time communicating effectively with each other. While they both are talking about the same product in the same company, are both well informed, and have some shared knowledge about the product and company, enough of their perspectives and knowledge bases are sufficiently disjoint as to make communicating difficult due to lack of shared vocabulary and knowledge.

As another example, a researcher and a product development manager each may have very different backgrounds, skill sets, perspectives, and priorities, and, as such, very different vocabularies. As they attempt to converse, each may use words and concepts that are clear to the party conveying the information, but may be either misunderstood or not understood at all by the other party.

### BRIEF SUMMARY

A term graph may be provided for a group G, wherein the group G is defined by a given set of values d for a set of dimensions D relative to a topic X. A method for providing a term graph may comprise retrieving a graph H, e.g., comprising terms related to a given entity and associated with the topic X. The method may further comprise identifying a node N that represents the topic X in the graph H. The method may also comprise identifying resources R associated with the topic X and associated with one or more values d of the group G. The method may further comprise compiling a list L of terms used in the identified resources R. The method may yet further comprise creating, starting from the node N, a connected subgraph S representing the term graph, wherein each node in S represents one of the terms from the list L and has a path to the node N.

A system for providing a term graph for a group G, wherein the group G is defined by a given set of values d for a set of dimensions D relative to a topic X, in one aspect, may comprise a graph creation module operable to execute on a processor and further operable to retrieve a graph H, e.g., comprising terms related to a given entity and associated with the topic X. The module may further identify a node N that represents the topic X in graph H, identify resources R associated with the topic X and associated with the values d of the group G. The module may also compile a list L of terms used in the resources R, and create, starting from the node N, a connected subgraph S representing the term graph, wherein each node in the subgraph S represents one of the terms from the list L and has a path to the node N.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates the above-described example flow for creating a dimension/topic term graph in one embodiment of the present disclosure.

FIG. 2 is a Unified Modeling Language (UML) class diagram that illustrates an example data model or data structure of a dimension/topic term graph in one embodiment of the present disclosure.

FIG. 3 illustrates an example of term graph G(x) output by a methodology of the present disclosure in one embodiment.

FIG. 4 illustrates an example of shared-term term graph output by a methodology of the present disclosure in one embodiment.

FIG. 5 illustrates an example ontology graph wherein one or more connector nodes may be missing for connecting a term graph.

FIG. 6 illustrates another example ontology graph with term graphs.

FIG. 7 illustrates a schematic of an example computer or processing system that may implement a dimension/topic term graph system in one embodiment of the present disclosure.

### DETAILED DESCRIPTION

A methodology is presented that provides better context and understanding for interpersonal and/or other communications, and thus facilitate better communication. For instance, parties communicating with one another may be provided with a way to understand each other's vocabulary and perspective, and to find common ground on which they can communicate. Specifically in one aspect, management of vocabularies or terminology within an organization of persons may be provided, by creating a graph data structure that can use terms located in documents relevant to a user, group, and/or time frame that are related to a particular issue or concept wherein the relative importance of those terms to the user, group or time frame are stored. The importance may be measured based on the amount of access or usage of the documents by the user or group of users. Additionally, a related data structure may provide for storing of metrics related to how strongly terms are shared between different users, groups or time frames. These types of data structures may be helpful in a large enterprise or government that can track document usage patterns by individuals within the enterprise. For example, the data structure of the present disclosure in one embodiment would be useful or helpful in a case in which a person in one area of the enterprise would like to have some understanding about the terms most relevant to person(s) in another area of the enterprise relative to an issue or concept. An interested user could, for example, retrieve a listing or word cloud with the most important terms relative to another person in the organization, e.g., chief executive officer (CEO) with respect to a specific product. A word cloud or tag cloud refers to a cluster or set of words or items graphically visualized together, e.g., indicating a type of relationship among the words or items relative to one another visually.

Accordingly, the methodology of the present disclosure in one aspect creates and defines data structures referred to as term graphs and shared-term term graphs. The data structures in one embodiment of the present disclosure store the importance measures of different (relevant) terms for different people and/or for different classified groups/dimensions, and various relationships between the terms. In the present disclosure, the terminology “graph” refers to a data structure.

The methodology of the present disclosure may be embodied or implemented as a system, method or process, and article of manufacture.

A methodology in one embodiment of the present disclosure may track the activities of all relevant parties with respect to a set of resources, e.g., all parties involved in a communication functioning within the same organization, although not necessarily in the same part of the given organization, or federated across different cooperating organizations. For example, one party may be a sales executive at a software company and the other party a product engineer at that same company. Examples of resources may include, but are not limited to, documents, emails, web pages, other files, or others.

The methodology of the present disclosure in one embodiment may access and make use of the current state of the art in enterprise content management, enterprise search, enterprise directories, web proxies, email, instant messaging, and NLP, e.g., used by an organization for their functions. In one aspect, the methodology of the present disclosure may utilize this combination of technologies to build a multidimensional graph which connects components to one another, e.g., connect documents (plain text, rich text, instant emails, news items, web content) to each other based on their business content; connect words to each other based on their use in documents; connect people to the content they access, author, etc.; connect documents and words to the different organizational roles held by people who accessed/used them at the time they accessed/used them (two variables—person's role @the time); connect documents and words to the times at which they were accessed/used.

In many organizations, an enterprise vocabulary may have been created and evolved over time. The enterprise vocabulary contains terms that have meaning in the context of this enterprise (and industry, location, etc.), synonyms for those terms, descriptions of the meaning of each term, and (wherever relevant) the teams and/or individuals within the organization that have business responsibilities that relate to the term. The vocabulary may contain all relevant business as well as technical terms. Such organization may also include an ontology built on top of the vocabulary which captures and maintains relationships between the vocabulary terms. Additional relevant industry vocabularies and ontologies containing relevant business as well as technical terms may have been provided and utilized. Briefly, as used in the technical field of computer science, an ontology is a set of concepts and their relations usually describing a domain or context, which represents knowledge in that domain or context.

A methodology of the present disclosure may take as input one or more dimension values and description for examination. Assuming a user wants to examine the use of, and/or variation in the use of, terms as one or more dimension D varies (where examples of varying dimensions include person, time, role of person, etc., or some other aspect of the usage context of the term), an input to the methodology of the present disclosure may include the values for D based on which to classify the resources into groups. Examples of classifications include but are not limited to: Classify by person; Classify by the time the documents were accessed (independent of who access them); Classify by the roles of the people who accessed them; Any combination of the above; and others. In addition, a short text description of a topic (X), e.g., the business issue, about which the examination is to be done, may be received as input.

Given the above inputs, the methodology of the present disclosure may include the following processing:
1. Identify the ontology node which most closely represents X.
2. For each Group G, defined by a classification, search for all resources in G which contain or relate to X. For example:
   i. If the groups are classified by person (i.e., D is person), a resource is related to that person if the person accessed it;
   ii. If the groups are classified by time or time frame (i.e., D is time or time frame), a resource is related to the time if it was created or accessed at/in that time/time frame;
   iii. If the groups are classified by role (i.e., D is role), a resource is related to that role if it was accessed by a person in that role;
   iv. If the groups are classified by a combination of dimensions—e.g., a person in a given time frame—a resource is related to that person+time frame if it was accessed by that person in that time frame.
3. For each G, given the set of resources, compile a list of all the terms (enterprise, industry, etc.) used in these resources, as well as their importance and links to the resources within which they were found.
4. For each G, create, starting from X, a subgraph (referred to as a term graph) of the ontologies mentioned above, where each node in the subgraph represents one of the terms found in the list from step #3 above, and has at least one path (in the ontology itself) to the ontology node representing X. The methodology has now created one term graph for each G. This graph need not be connected, as the “connector” nodes found in the ontology might not be in G.

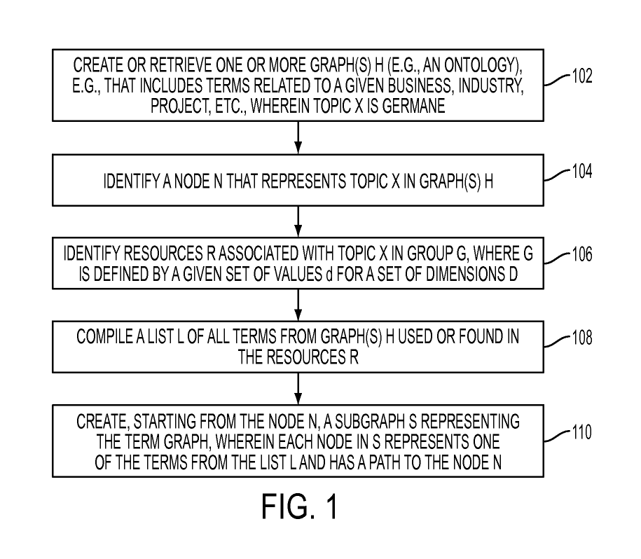

FIG. 1 illustrates the above-described example flow for creating a dimension/topic term graph in one embodiment of the present disclosure, for instance, for a group G, wherein G is defined by a given set of values d for a set of dimensions D relative to a topic X. At 102, graph H (e.g., ontology graph) is created or retrieved that, e.g., includes terms related to a given entity, (e.g., business, industry, project, or other domain or area), wherein topic X is germane or is associated with topic X.

At 104, a node (referred to here as node N) that represents topic X is identified from graph H.

At 106, resources (referred to here as resources R) are identified that are associated with topic X from the resources in group G, for instance, resources that are used or accessed by or otherwise associated with dimensions that define or classify group G.

At 108, a list (referred to here as list L) is compiled that contains the terms used in the resources identified at 106.

At 110, a term graph is created by creating, starting from node N, a connected subgraph (referred to here as subgraph S) in graph H, each node of subgraph S representing one of the terms from list L, and connected in the ontology to node N. Hence, for example, the terms from list L that are also represented as nodes in graph H make up a connected subgraph S. In another embodiment of the present disclosure, even if a term found in the resources does not appear in graph H (e.g., ontology graph), if that term is found to occur frequently enough (e.g., based on a predetermined or predefined threshold value, e.g., n number of times and/or within a given period of time duration) in the resources in group G, graph H (e.g., ontology graph) may be updated to include that term, e.g., by add a node that represents that term to graph H.

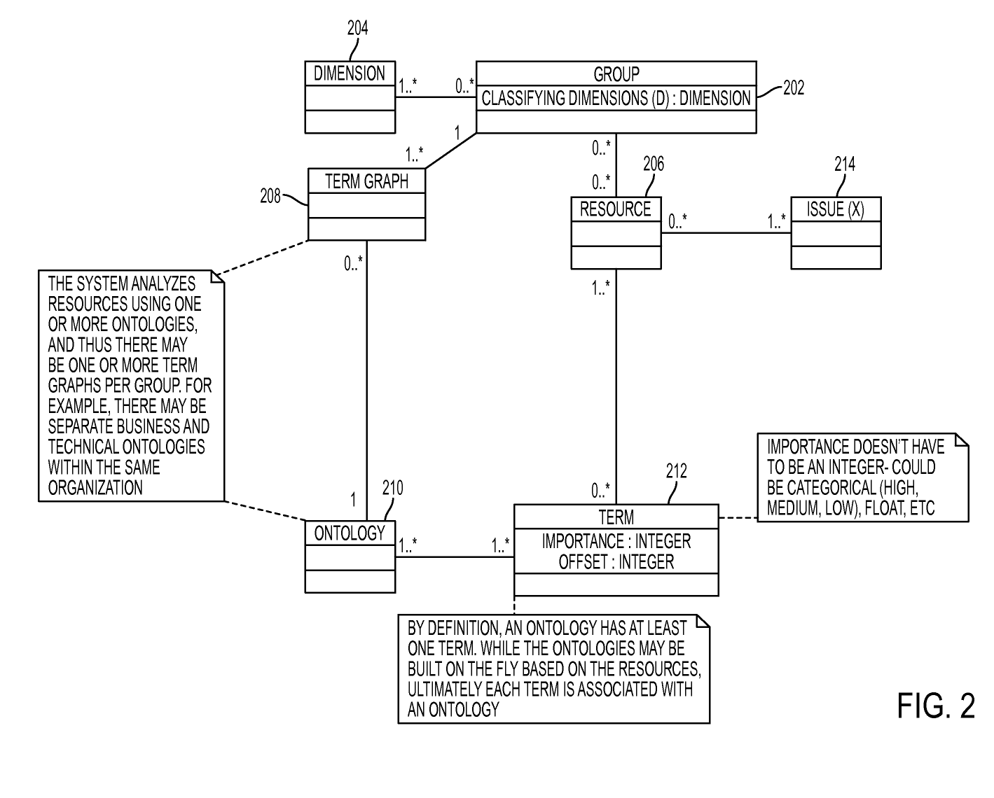

FIG. 2 uses a UML class diagram to illustrate an example data model or data structure of a dimension/topic term graph in one embodiment of the present disclosure. Resources are grouped or classified by one or more dimensions. Hence, a group node or component 202 contains or points to one or more dimension nodes or component 204, based on which the group is classified. The group node 202 also contains or points to zero or more resource nodes or component 206 that are in that group. The resource node 206 contains or references an issue node 214 representing topic X A term graph node or component 208 contains or points to one or more group node 202. Resources may be analyzed using one or more ontologies 210, and thus there may be one or more term graphs 208 per group, but only one term graph per ontology for each group. Term node or component 212 represents a term found in a resource represented by a resource node 206, and may contain an importance value associated with the term and an offset (location, e.g., by byte count, line number, etc.) in the resource where the term is found. Importance value may be represented as an integer, or categorical indication such as high, medium, low, or float, or by any other representation. Ontology 210 has at least one term. While the ontologies may be built on the fly based on the resources, each term is associated with an ontology. The cardinalities shown in the UML diagram in FIG. 2 (e.g., “1 . . . *”, “0 . . . *”, “1”) represent in one embodiment the data model of the present disclosure that is used to store data associated with many issues, groups, term graphs, ontologies, resources, dimensions, and other data.

More specifically, the outputs may include a term graph, also referred to as connected tag cloud, which is created for each G(x), and a shared-term term graph (STTG) also referred to as a joint connected tag cloud. A term graph allows one to quickly see what terms/concepts are relevant to each G, and how important they are (for one or more measures of importance), vis-à-vis X. An STTG allows one to see what terms/concepts are most strongly shared between different Gs. In one embodiment of the present disclosure, a user may choose to access and/or view a term graph of one G, or of multiple Gs, or of all Gs. One can also choose whether or not to access and/or view the STTG. An appropriate user interface or graphical user interface (GUI) may be built or provided for allowing a user to interact in creating and viewing the term graphs.

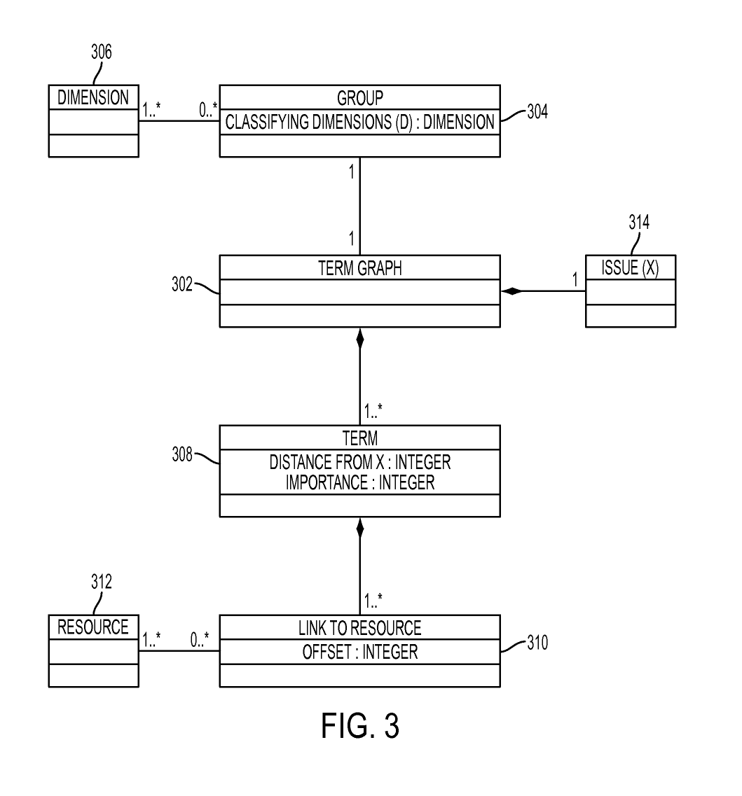

FIG. 3 illustrates an example of term graph G(x) output by a methodology of the present disclosure in one embodiment. A separate term graph is created of the terms/concepts found to be relevant to each G(x). Any two term graphs may be connected when they share at least one term. Each term graph (e.g., 302) in one embodiment of the present disclosure includes one or more D values (d) 306 that defined the classification for G(x) 304. As an example, a visualization of a D value (e.g., a picture from a corporate directory) may be generated and displayed near the term graph in a GUI to remind a user which D values define the term graph being viewed. A term graph 302 also includes a node 308 for each term in G(x), with node attributes, e.g., including: the term, the shortest distance from the term to X in the ontology, the term's importance which represents the importance of a term in G(x), physical location of user when using the term, client device from which the user employs the term. Other attributes may be included. A distance represents how closely the terms are related. For example, the distance from the term to X represents how closely that term is related to X (given topic).

Importance, for example, can be determined by: frequency of use, location of usage, use in certain key documents, use by certain key people, or use in certain key contexts, or any combination of the above. The importance of a term in G vis-à-vis X may be represented by an importance number. The importance number may be used to determine a tag's display size, and/or may be displayed, for example, below the tag.

Optionally, a term graph 302 may also include links to all the resources 310, 312 wherein the term was used in conjunction with X 314 and relevant to G's D value. Such node 310 may include as attributes, offsets (e.g., location of the term in the resource) to all instances of the term in each resource linked to, e.g., to allow quick access to the term in the context of the resource. In one aspect, links to all the resources wherein the tag's term was used in conjunction with X and relevant to G's D value may be stored with each term in each connected term graph. These links may be used by a GUI to allow users to access the resources. For example, when one tag cloud, representing a term graph, for one G, is being displayed by itself, selecting (by for example, clicking, touching, etc.) a tag or a number may show a pop-up view (or another visualization) which provides links to all the resources wherein the tag's term was used in conjunction with X and relevant to G's D value. Selecting a link may display the document with all instances of the selected term and of X highlighted. Seeing the document itself gives the user the opportunity to understand better the context in which the term was used.

When the user accesses a document, that access itself could designate the document as being relevant to multiple D values (e.g., the person accessing it, their role, the time, etc.). One can choose to include or exclude this access from the accesses recorded in the methodology of the present disclosure.

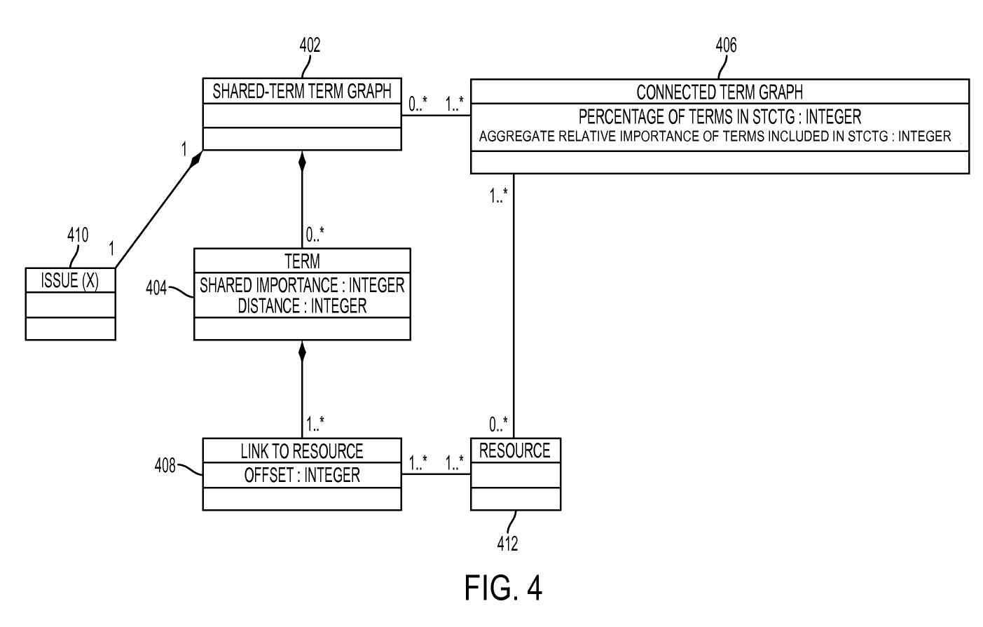

FIG. 4 illustrates an example of shared-term term graph output by a methodology of the present disclosure in one embodiment. As discussed above, the methodology of the present disclosure may also create as output a shared-term term graph (STTG), which includes the terms found in the term graphs of two or more Gs of interest, for instance, whose individual term graphs are being displayed and/or used. Those term graphs need not be connected, as the “connector” nodes found in one G's term graph may be absent from another G's term graph. An STTG, also referred to as a joint connected tag cloud (joint connected tag cloud may present a group of tag clouds; the need for multiple tag clouds, instead of one tag cloud, arises if the joint term graph (STTG) is not a connected graph, in which case each tag cloud in this group of tag clouds will represent one connected subgraph) is created to represent a joint term graph. If desired, one can choose to generate all of the n choose k STTGs when a new G is added, or to postpone generation until a given STTG is requested. Generating upon addition can result in faster response time for subsequent requests, e.g., accesses and/or views.

An STTG 402 in one embodiment may include a node 404 for each term shared by the two or more connected term graphs 406 of interest. A term is shared if it is present in two or more of the connected term graphs of interest. Node attributes of a term node 404 may include the term, the shortest distance of that term from X 410 in the STTG, and the shared importance of the term, which indicates the importance of the term in the context shared by the two or more connected term graphs 406 in which it appears. Shared importance may be determined, for example, by the weighted number of shared usages, where the weight of each shared usage may be affected by any of the factors used to establish importance of a term in a single term graph. Shared usages indicate a level of shared context between the multiple values of D (for example, where D is person, a shared use indicates that the term is useful for facilitating communication between people).

An STTG 402 may also include or store links to all the resources 408 wherein there was a shared usage. Offsets to all instances of the term in each resource linked to may be stored as well, e.g., to allow quick access to the term in context of the resource. For each of the connected term graphs of interest 406, an STTG 402 may also include the percentage of its terms present in the STTG and/or the aggregate relative importance of the terms included in the STTG. For example, if a source graph has 100 terms, 5 of which have a high importance and 50 of which have a low importance, inclusion of the 5 of high importance may result in a greater aggregate relative importance than inclusion of 20 terms of low importance. The entire process can be repeated where the two or more term graphs share the identical values of D, but have different values of X. In such a case, the STTG facilitates comparing the relative importance, distance, etc., for the same classified dimension as X varies (e.g., same user (D) for different topics or issues (X)).

Each term may be represented as a tag. The distance of a given tag from X in the tag cloud represents the distance of that tag from X in the joint term graph. As discussed above, the importance of a tag may be determined by the number of shared usages, since more shared usages indicates that the term is a stronger shared context between multiple values of D (This may indicate, for example, the term is better for facilitating communication between people). A shared usage occurs, e.g., when all two or more values of D are deemed relevant to the same resource where the term was used in conjunction with X, or the resource is contained in two or more Gs. For each shared usage, the joint connected tag cloud may store links to all the resources wherein there was a shared usage. Offsets to all instances of the term in each resource linked to may be stored as well to allow quick access to the term in context of the resource.

The methodology of the present disclosure in one aspect provides for the notion of per-user (or another dimension) importance of terms in an ontology, and method to define the importance of terms per user (or another dimension). The methodology provides a mechanism to analyze not just the contents of documents, but also document access/usage by individual users and/or other dimensions without said usage consisting of changing the document or referring/linking to it in another document, and where usage affects the importance measures of terms contained therein for the individual user (or another dimension), and said importance is tracked/stored, etc.

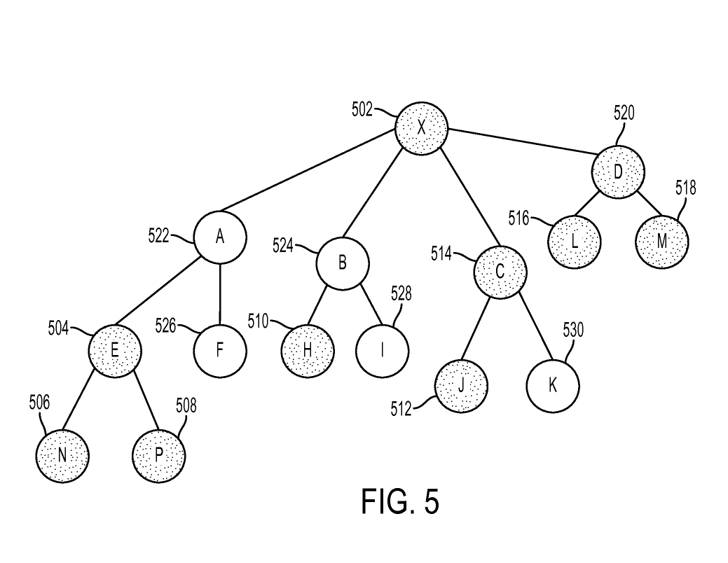

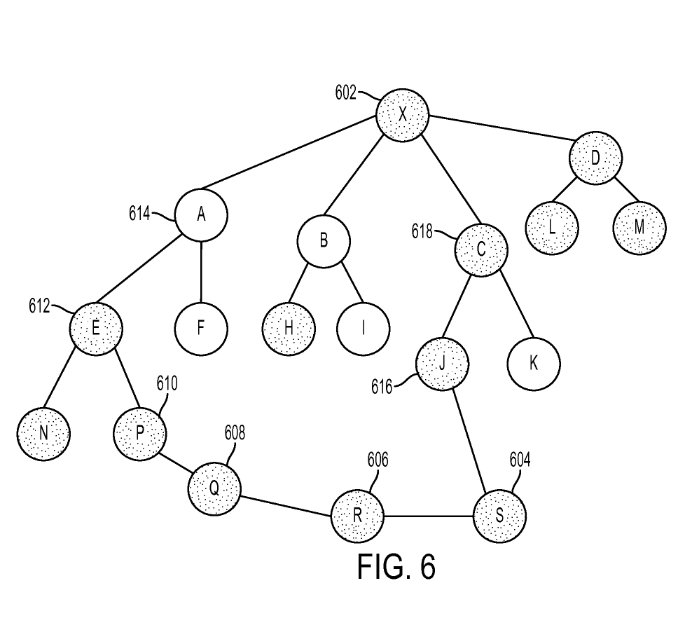

A term graph of the present disclosure associated with a group need not be connected, as the “connector” nodes found in the ontology might not be in the group. FIG. 5 illustrates a sample ontology represented as a graph illustrating this scenario. X 502 is the node representing the topic. All other highlighted nodes (504, 506, 508, 510, 512, 514, 516, 518, 520) represent terms found in a list of terms (FIG. 1, 108). While X 502, D 520, C 514, L 516, M 518, and J 512 are all connected to each other (directly or indirectly), i.e., have edges between them, if all nodes that are not found in the list (A 522, B 524, F 526, I 528, K530) are eliminated, H 510 is not connected to any other highlighted nodes, and E 504, N 506, P 508 while connected to each other (directly or indirectly) are not to the other highlighted nodes (510, 512, 514, 516, 520, 518, 502). For the graph of FIG. 5 to be a connected graph, nodes A 522 and B 524 are needed. However, they (522, 524) are not in the list, so they (522, 524) are the “missing connector nodes” whose absences from the list results in it being a disconnected graph. FIG. 6 illustrates another example ontology. In this figure, S (604) has two paths to X (602): R-Q-P-E-A-X (606-608-610-612-614-602) and J-C-X (616-618-602). In the first path, S (604) is 6 nodes away from X (602), a.k.a. at a distance of 6, and in the second path S (604) is 3 nodes away from X (602), a.k.a. at a distance of 3 in the graph. In this example, the shortest distance of S (604) to X (602) is 3.

As discussed above, term graphs of the present disclosure may facilitate communications and/or provide better insight and understanding of an issue or topic along a dimension or across different dimensions, for example, in an organization. For example, consider term graphs built using one or more ontologies of the organization, according to a methodology of the present disclosure in one embodiment, along a user dimension (D) for different users (values d of D), e.g., user A (a vice president of analytics products), user B (a chief statistician), user C (development manager), user D (visualization technical guru), and user E (a software engineer) for a topic, e.g., a software product. An organization's ontology may have a node that represents the software product in its ontology graph (data structure). Each of those users has a term graph related to that topic (in this example, software product) and which is linked to the ontology node. The term graph may include terms associated with the topic, which terms have been used or appear in various resources accessed (or otherwise used) by the corresponding user, e.g., internal documents, presentations, emails, and/or other items associated with the organization, and/or publicly available information, e.g., information on competitors, and other information. The term graph may also include importance measures of how significantly a term is treated or considered by the user. Such term graphs would provide an overview of different perspectives those users (whose jobs may have different focuses) have regarding albeit the same topic.

For example, one or more of those users (user A, user B, user C, user D, user E) may prepare for a meeting to be held among them, by viewing or otherwise evaluating the term graphs (e.g., exploring the tag clouds that present the term graphs) associated with one or more of the users and determining based on, e.g., the importance values stored for the terms in the term graphs, what aspect about the same topic each user is focused on or more is concerned about. In one embodiment, the term graphs may be retrieved or presented as tag clouds for exploring, e.g., by a query that queries the desired ontology with a specified user and topic.

The one or more of those users may also explore an STTG, e.g., via presentation of a corresponding STTC, to determine which terms are shared among those different users' term graphs. This way, it is possible to determine what users have in common, e.g., explore in a single view, what same terms and resources those users have used.

While the above example illustrated one use case of a methodology of the present disclosure, with an organization as entity and users as group dimension, it should be understood that the methodology is not limited to only such example scenario. For example, term graphs may be created for different dimensions, combination of different dimensions, and/or different entities. For instance, term graphs may be created and explored along a time dimension, e.g., terms used in different duration of time, or combinations of multiple dimensions. Ontologies need not be limited to an organization's ontology, but can be related to another entity, e.g., logical entity, which shares terms and concepts. For example, there may be ontologies associated with an industry, business, project, and others.

The term graph and STTG, and the method of creating the same disclosed in the present disclosure may have many different applications. For instance, they may be used as an application/tool for preparing for meetings, presentations, etc., and may help the presenter understand the context and perspective of each attendee. Another application may be as an add-on to email and/or instance messaging (IM) clients, e.g., to provide instant context when communicating via those means to help a user quickly decide what terms to use with the other party, and also help a user understand the use of a given term by the other party. Yet another application may be as a tool used in team selection and communication. Such tool may allow a user to select one or more names/identifications (IDs) in a directory, contacts list, etc., or enter one or more names, provide a short text description of the business issue, and see tag clouds. This can be used to select team members based on their amount of shared usages with each other, select teams members based on their shared usage of key terms relevant to the business issue, facilitate communication between the team members by using shared terms and better understand each others' contexts.

Another example application is in multi-dimensional data exploration, e.g., where each tag cloud is for one set of dimensions, and the joint tag cloud shows comparative importance for some importance measure in the data sets. For example, considering each term as a gene, different sequences, pools, etc. can be compared, e.g., see what they have or do not have in common. As another example, health profiles of sets of people or individual people may be compared. Yet another example may be in identifying most important health, business, or other issues to address for a given set of people, other dimensions, entities, etc.

Still another example application may be in comparative monitoring, e.g., to have events or feeds feeding two tag clouds, with importance measures changing based on the input. For example, the data structure of the present disclosure may be used to monitor the terms such as enterprise or organization names, “database”, “hardware”, etc., to watch for relative importance of the enterprises related to given markets, customers, etc.

Yet another application may be in federation and/or sharing of tag clouds, such that multiple groups/dimension class can selectively understand, and share with, each other. For example, selective information may be shared with customers about products. Social networking software may also utilize the data structure of the present disclosure, for example for allowing people to get to know each other, find people with similar terms/tags, and get to know each other via the tag clouds.

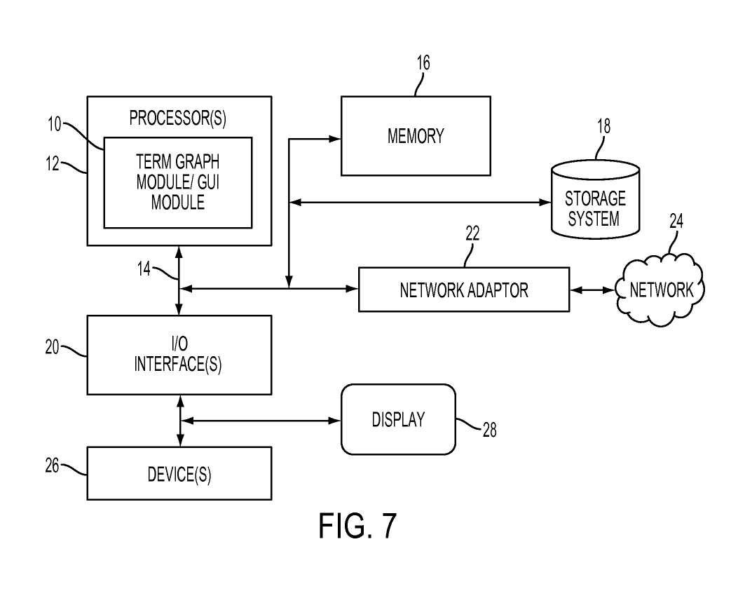

FIG. 7 illustrates a schematic of an example computer or processing system that may implement the dimension/topic term graph system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 7 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a dimension/topic term graph module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method of providing a term graph for a group G, wherein G is defined by a given set of values d for a set of dimensions D relative to a topic X, comprising:
retrieving a graph H comprising terms related to a given entity and associated with the topic X;
identifying a node N that represents the topic X in the graph H;
identifying resources R associated with the topic X and associated with one or more values d of the group G;
compiling, by the processor, a list L of terms used in the identified resources R; and
creating, by the processor, starting from the node N, a connected subgraph S representing the term graph, wherein each node in S represents one of the terms from the list L and has a path to the node N.

2. The method of claim 1, wherein the resources R comprise one or more of documents, graphics, audio, communications material, or combinations thereof.

3. The method of claim 1, further comprising persistently storing the given set of values d, the set of dimensions D, the topic X, the graph H, the resources R, the list L, and the connected subgraph S in a database.

4. The method of claim 1, wherein the dimensions D comprises one or more of particular user, specification of a role, or specification of a time range, or combinations thereof.

5. The method of claim 1, further comprising obtaining importance measure associated with each of the resources R.

6. The method of claim 5, further comprising storing the importance measure.

7. The method of claim 1, further comprising obtaining a distance value of the each node in S from node N.

8. The method of claim 7, further comprising storing the distance value.

9. The method of claim 1, wherein the topic X is specified by a text description.

10. The method of claim 1, wherein two or more term graphs are provided respectively associated with two or more groups G, wherein a node representing a term commonly included in the two or more groups G serves as a connection between the two or more groups G, to create a shared-term term graph.

11. The method of claim 10, wherein the shared-term term graph is generated automatically in response to a new term graph being added.

12. The method of claim 10, wherein the shared-term term graph is generated in response to receiving a request to create the shared-term term graph.

13. The method of claim 10, wherein an importance associated with a term I is a function of an importance associated with the term I in each of the term graphs, the function assigning different weights to said each of the term graphs, wherein the importance associated with the term I indicates a strength of a shared context between the two or more groups G.

14. The method of claim 1, wherein the node in S representing the term in the list L stores one or more links respectively to one or more of the resources R where the corresponding term in the list L was used.

15. The method of claim 14, wherein the node in S representing the term in the list L further stores one or more offsets where the term appears in the resources R.

16-25. (canceled)
